(19) United States
(12) Patent Application Publication
(10) Pub. No.: US 2024/0126971 A1
(43) Pub. Date: Apr. 18, 2024

(54) LAYOUT DESIGN SYSTEM USING DEEP REINFORCEMENT LEARNING AND LEARNING METHOD THEREOF

(71) Applicant: SAMSUNG ELECTRONICS CO, LTD., Suwon-si (KR)

(72) Inventors: HYUNJOONG KIM, Suwon-si (KR); TAEHYUN KIM, Suwon-si (KR); JICHULL JEONG, Suwon-si (KR); EUIHYUN CHEON, Suwon-si (KR)

(73) Assignee: SAMSUNG ELECTRONICS CO, LTD., Suwon-si (KR)

(21) Appl. No.: 18/124,992

(22) Filed: Mar. 22, 2023

(30) Foreign Application Priority Data
Oct. 14, 2022 (KR) 10-2022-0132289

(51) Int. Cl. G06F 30/392

(52) U.S. Cl. CPC G06F 30/392

(57) ABSTRACT

A layout optimization system for correcting a target layout of a semiconductor process includes a deep reinforcement learning (DRL) module, a memory storing instructions, and a processor configured to execute the instructions to receive a target layout, generate, by the DRL module, a prediction layout by applying a simulation to the target layout, generate, by the DRL module, an optimal layout based on the prediction layout, and apply a size correction to at least one pattern of the prediction layout based on the optimal layout.

### CROSS-REFERENCE TO RELATED APPLICATION

This application is based on and claims priority to Korean Patent Application No. 10-2022-0132289, filed on Oct. 14, 2022, in the Korean Intellectual Property Office, the disclosure of which is incorporated herein by reference in its entirety.

### BACKGROUND

### 1. Field

Example embodiments of the disclosure relate to a semiconductor design system, and more particularly, to a layout design system using deep reinforcement learning and a learning method thereof.

### 2. Description of Related Art

A semiconductor manufacturing process is implemented may be a combination of various procedures such as etching, depositing, planation, growth, and implanting. Etching may be performed by forming a pattern of photoresist on the object and removing portions of the object not covered by the photoresist using chemicals, gases, plasmas, ion beams, or the like. In the process of performing etching, process errors may occur due to various factors. Various factors that cause process errors may be due to the environment or characteristics of the process, or may be due to the characteristics of semiconductor patterns implemented by a photoresist pattern or etching. Process errors due to the characteristics of patterns may be predicted using artificial intelligence models. The layout of the patterns may be corrected using a skew (e.g., a difference between a predicted pattern and a target pattern) with the predicted value.

However, when the skew is applied in a predicted environment, correcting one pattern affects the environment of other patterns located nearby. That is, whenever pattern correction is applied, a change in the environment may accompany the pattern correction. Therefore, regardless of the accuracy of the prediction, there is a limit to forming a desired target pattern. This becomes more apparent and affecting as the degree of integration of semiconductor devices increases and the semiconductor processes continue to be miniaturized.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

One or more example embodiments provide a layout optimization system and a learning method for adjusting and applying a predicted layout generated for process proximity correction by reflecting mutual influences between patterns.

Additional aspects will be set forth in part in the description which follows and, in part, will be apparent from the description, or may be learned by practice of the presented embodiments.

According to an aspect of an example embodiment, a layout optimization system for correcting a target layout of a semiconductor process may include a deep reinforcement learning (DRL) module, a memory storing instructions, and a processor configured to execute the instructions to receive a target layout, generate, by the DRL module, a prediction layout by applying a simulation to the target layout, generate, by the DRL module, an optimal layout based on the prediction layout, and apply a size correction to at least one pattern of the prediction layout based on the optimal layout.

According to an aspect of an example embodiment, a learning method of a layout optimization system may include receiving a target layout, generating a predicted layout based on the target layout, generating a plurality of action values by performing a simulation on the predicted layout, receiving a change to at least one pattern of the predicted layout as an action input, selecting a first action value of the plurality of action values corresponding to the action input, and determining a loss function by comparing the selected first action value with a second action value corresponding to the target layout.

According to an aspect of an example embodiment, a method may include receiving a target layout, generating a prediction layout by applying a simulation to the target layout, generating an optimal layout based on the prediction layout, and applying a size correction to at least one pattern of the prediction layout based on the optimal layout.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is a diagram illustrating a method of compensating a critical dimension (CD) according to an environment when process proximity correction (PPC) is applied, according to an embodiment;

FIG. 2 is a diagram illustrating a hardware structure of a layout optimization system according to an embodiment;

FIG. 3 is a flowchart illustrating a method of applying PPC according to an embodiment;

FIG. 4 is a diagram illustrating a layout optimization method using a deep reinforcement learning module according to an embodiment;

FIG. 5 is a flowchart illustrating operation S130 of FIG. 3 according to an embodiment;

FIG. 6 is a diagram illustrating a target layout and a partial area of a predicted layout generated through simulation according to an embodiment; and

FIGS. 7A, 7B, 7C, 7D and 7E are diagram illustrating a process of proximity correction using the deep reinforcement learning according to an embodiment.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

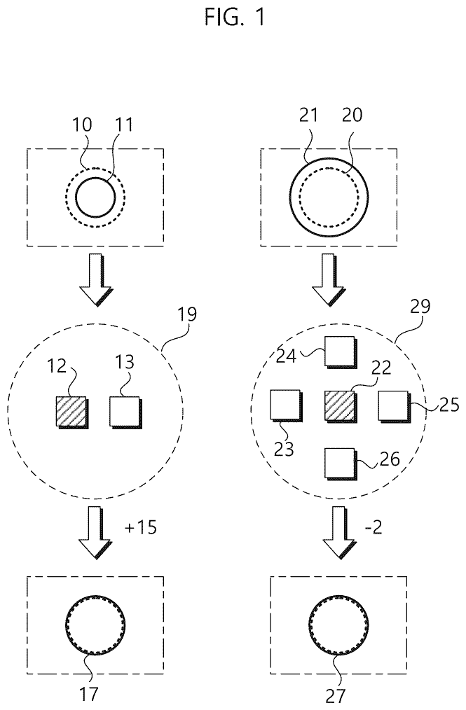

FIG. 1 is a diagram illustrating a method of compensating a critical dimension (CD) according to an environment when process proximity correction (PPC) is applied, according to an embodiment. Referring to FIG. 1, the shape of the target pattern may be corrected by adjusting the CD of the pattern based on the number of patterns distributed in the semiconductor etching process.

In a first process environment 19 in which one pattern 13 is formed around the pattern 12, a predicted pattern 11 may be generated as indicated by a circular dotted line. The prediction pattern 11 may be provided in a relatively small size compared to the target pattern 10. In this case, when the layout is corrected using a value (e.g., ‘+15’) corresponding to the difference (hereinafter referred to as “skew”) between the predicted pattern 11 and the target pattern 10, then the newly formed pattern 17 approaches the size of the target pattern 10.

In a second process environment 29 in which four patterns 23, 24, 25, and 26 are formed around the pattern 22, a predicted pattern 21 may be generated as indicated by a circular dotted line. The predicted pattern 21 may be predicted with a relatively large size compared to the target pattern 20. In this case, the design layout may be corrected using a value corresponding to a skew, which is a difference between the predicted pattern 21 and the target pattern 20 (e.g., ‘−2’). Then, the newly formed pattern 27 approaches the size of the target pattern 20.

As described above, in order to solve the issues related to the distribution of the CD, the CD of the design patterns may be adjusted in consideration of the number of neighboring patterns and/or the distance between the neighboring patterns. However, after obtaining the size of the skew for the correction of the CD, a new environmental change may occur when the derived skew is applied to the layout. Thus, disclosed herein is a layout optimization method for compensating for issues resulting from environmental changes that may occur when a skew is applied to a layout.

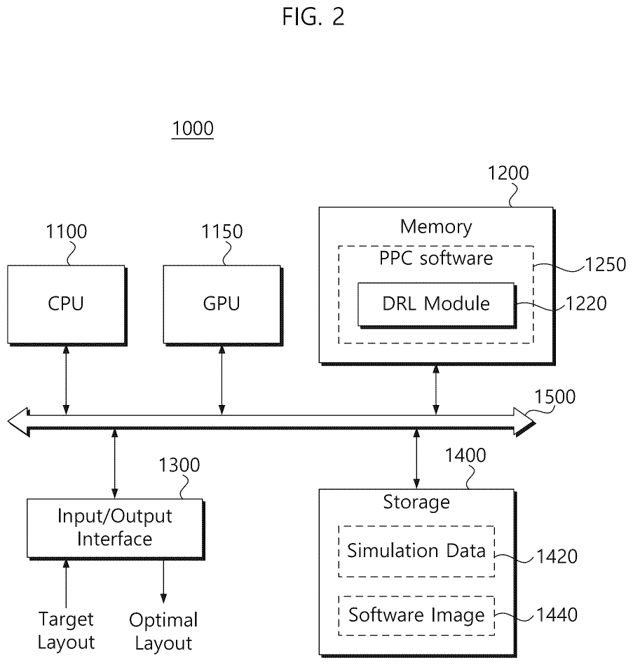

FIG. 2 is a diagram illustrating a hardware structure of a layout optimization system according to an embodiment. Referring to FIG. 2, the layout optimization system 1000 may include a central processing unit (CPU) 1100, a graphical processing unit (GPU) 1150, a memory 1200 (e.g., a volatile memory, a non-volatile memory, etc.), an input/output interface 1300, a storage 1400, and a system bus 1500. The layout optimization system 1000 may be configured as a dedicated device for executing PPC software 1250 on the memory 1200. However, the layout optimization system 1000 may be a device that runs a design program such as a technology computer-aided design (TCAD) simulation program, electronic computer-aided design (ECAD) simulation program, etc.

The CPU 1100 may execute software instructions (e.g., application programs, operating systems, device drivers, etc.) stored in a memory (such as storage 1400, memory 1200, or other memory) in the layout optimization system 1000. The CPU 1100 may execute instructions corresponding to an operating system (OS) loaded into the memory 1200. The CPU 1100 may execute instructions corresponding to various application programs to be driven based on an OS. For example, CPU 1100 may execute instructions corresponding to PPC software 1250 loaded into the memory 1200. The PPC software 1250 may include a deep reinforcement learning (DRL) module 1220. The CPU 1100 may perform a reinforcement learning operation of the DRL module 1220 by driving the PPC software 1250 together with the GPU 1150 to be described later. In addition, the CPU 1100 and/or the GPU 1150 may generate, with the DRL module 1220, an optimized after cleaning inspection (ACI) CD corresponding to the target layout.

The GPU 1150 may perform various graphics operations or parallel processing operations. That is, the GPU 1150 may include an advantageous operation structure for parallel processing (i.e., repeatedly processing similar operations). In some embodiments, the GPU 1150 may have a structure that may be used for various operations requiring high-speed parallel processing as well as graphic operations. For example, operations corresponding to general purpose tasks other than graphics processing tasks may be referred to as a general purpose computing on graphics processing units (GPGPU). GPGPU may be utilized for video encoding, as well as in fields such as molecular structure analysis, code decoding, and weather change prediction. In particular, the GPU 1150 may perform the efficient learning operation of the DRL module 1220 together with the CPU 1100.

The OS or application programs may be loaded into the memory 1200. When the layout optimization system 1000 boots, an OS image stored in the storage 1400 may be loaded into the memory 1200 according to a booting sequence. All input/output operations of the layout optimization system 1000 may be supported by an operating system OS. Similarly, application programs selected by the user or to provide basic services may be loaded into the memory 1200. In particular, the PPC software 1250 may also be loaded into the memory 1200 from the storage 1400. The memory 1200 may be a volatile memory such as static RAM (SRAM) or dynamic RAM (DRAM), or a non-volatile memory such as phase-change RAM (PRAM), magnetoresistive RAM (MRAM), resistive RAM (ReRAM), ferroelectric RAM (FRAM), read-only memory (ROM), NOR flash memory, etc.

The PPC software 1250 may perform PPC calculations and procedures using the DRL module 1220 according to an embodiment of the disclosure. In particular, the DRL module 1220 used in the PPC software 1250 may use the predicted layout generated through simulation. As used herein, a “predicted layout” and a “prediction layout” may be used interchangeably. The DRL module 1220 may extract an optimal correction value reflecting the environmental change caused by CD adjustment while time-dependently reinforcing the patterns of a predicted layout. For example, the DRL module 1220 may obtain a DRL action value (also referred to as a Q-value) function from simulation data 1420 stored in the storage 1400 that corresponds to a correction value generated through simulation.

A Q-value for images of various target patterns may be provided in the form of functions in the simulation data 1420. That is, the simulation data 1420 may include predicted layout information for an image of a target layout. In addition, an action value function for the correction of patterns included in the target layout may be provided using the simulation data 1420. To generate the simulated data 1420, a convolutional neural network (CNN) may be used, for example.

When DRL by the DRL module 1220 is completed, the CPU 1100 may generate an optimal layout corresponding to an ACI image, which is a target image input through the input/output interface 1300. The optimal layout may be provided in the form of an optimal correction value or image for each pattern. That is, the CPU 1100 may generate PPC data or an image corresponding to the target layout using the DRL module 1220 for which reinforcement learning has been completed. For example, the DRL module 1220 may generate an optimal correction value reflecting a temporally changing environment while applying and reinforcing the correction value provided through simulation in a time-dependent manner.

The input/output interface 1300 may be controlled by the CPU 1100 (and/or GPU 115) to receive and process user inputs, as well as output information to a user, using user interface devices. For example, the input/output interface 1300 may be connected with a keyboard or a monitor to receive commands or data from a user. A target layout (e.g., an ACI layout) for DRL of the DRL module 1220 may also be provided through the input/output interface 1300. In addition, the input/output interface 1300 may output progress or processing results in learning or pattern generating operations of the layout optimization system 1000. For example, the input/output interface 1300 may output optimal layout data derived from a result of the DRL module 1220. The target layout and the optimal layout may be provided as numerical data or image data representing the layout.

The storage 1400 may be provided as a storage medium of the layout optimization system 1000. The storage 1400 may store application programs, an OS image, a software image 1440 of the PPC software 1250, and various data. In addition, the storage 1400 may store simulation data 1420 for providing action value functions corresponding to various actions in the PPC software 1250. The storage 1400 may be provided as a memory card (MultiMediaCard (MMC), embedded MMC (eMMC), secure digital (SD), MicroSD, etc.), a hard disk drive (HDD), etc. The storage 1400 may include a NAND-type flash memory having a large storage capacity. Alternatively, the storage 1400 may include a next-generation nonvolatile memory such as PRAM, MRAM, ReRAM, FRAM, or NOR flash memory.

The system bus 1500 may provide a network connection for the layout optimization system 1000. Through the system bus 1500, the CPU 1100, the GPU 1150, the memory 1200, the input/output interface 1300, and the storage 1400 may be connected and may exchange data. However, the configuration of the system bus 1500 is not limited to the above description and may further include mediation configurations for efficient management.

The layout optimization system 1000 may perform a PPC calculation for generating an optimal layout for a target layout according to the operation of the PPC software 1250. In particular, the PPC software 1250 may apply the PPC by time-dependently reinforcing a correction value provided from simulation data using the DRL module 1220. Accordingly, the PPC reflecting environmental changes may be generated based the correction of each of the patterns according to the application of the time-dependent correction.

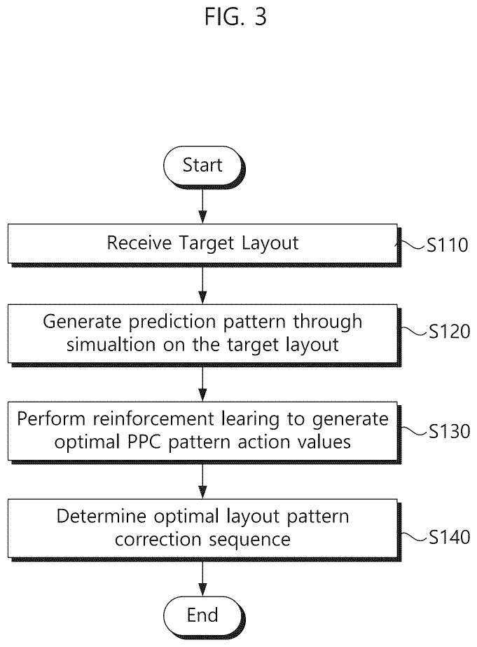

FIG. 3 is a flowchart illustrating a method of applying PPC according to an embodiment. As described herein, the DRL module 1220 is described as performing various actions. The functions of the DRL module 1220, as well as the PPC software 1250 may be described as being functions corresponding to instructions or code executed by a processor, such as CPU 1100, GPU 1150, etc. However, example embodiments of the disclosure are not limited as such, as the PPC software 1250, including the DRL module 1220, may include a separate processor dedicated to executing the instructions or code corresponding to the DRL module 1220/PPC software 1250. Referring to FIG. 3, the DRL module 1220 may generate an action value function from a simulation result using a neural network and perform DRL using the action value function. Optimal correction data for forming a target pattern may be obtained through DRL.

In operation S110, the layout optimization system 1000 may receive a target layout to which a PPC is to be applied. For example, the target layout may be a layout or CD determined to be obtained upon inspection after cleaning ACI.

In operation S120, the layout optimization system 1000 may generate a prediction pattern through simulation on the target layout. For example, the simulation may be performed using a pretrained CNN for generating a target pattern. A CNN used for the simulation may take a target layout as an input and output a plurality of action values (Q-values) corresponding to a plurality of actions. That is, the CNN may output action values (Q-values) for adjusting a plurality of patterns together through predictive simulation of a target layout. The CNN may generate action values for various prediction patterns generated when adjusting each pattern for a target layout. The action value may represent the total sum of future rewards expected when an action is input in a specific state.

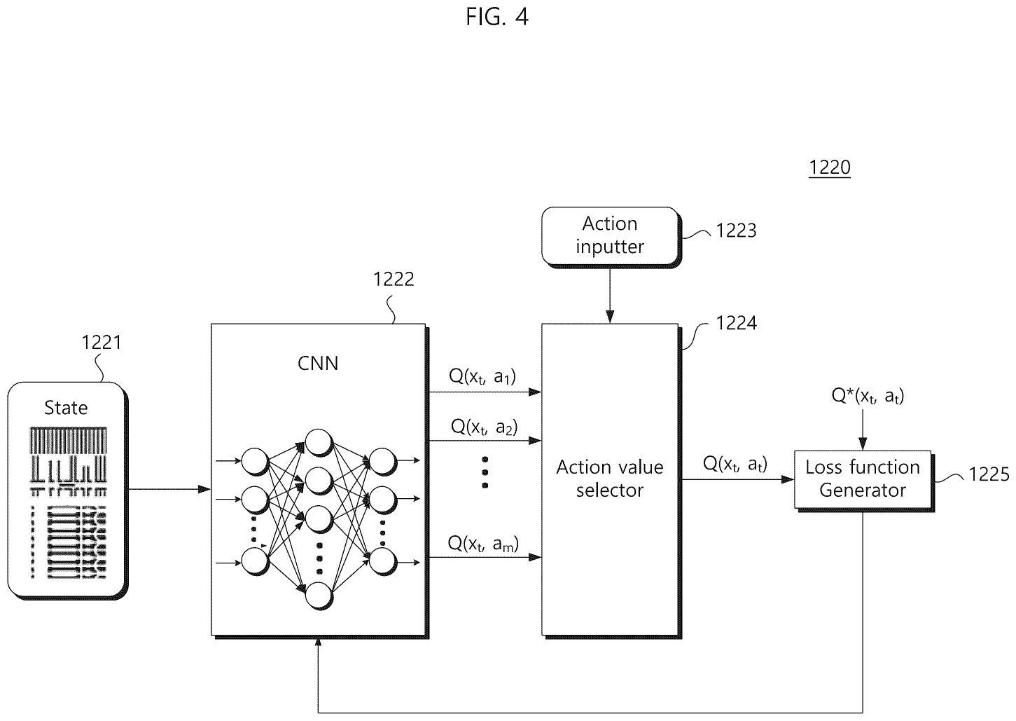

In operation S130, the layout optimization system 1000 may perform reinforcement learning to generate an optical PPC pattern using the simulation data as action values. The DRL module 1220 may perform reinforcement learning that applies the correction of each pattern in a time-dependent manner. For example, the DRL module 1220 may receive a layout pattern as an input (e.g., as a ‘state’) and receive size correction of each pattern as another input (e.g., as an ‘action’). The layout pattern may be a target layout upon ACI. Further, the DRL module 1220 may generate an action value (Q-value) corresponding to the input state (‘state’) and action (‘action’). The action value (Q-value) may be generated using a CNN that performs predictive simulation on the target layout. The DRL module 1220 may determine a loss function or reward by comparing the action value (Q-value) according to the correction of each pattern with the optimal action value (Q* of FIG. 4) of the target layout.

In operation S140, the layout optimization system 1000 may determine an optimal layout pattern correction sequence. The optimal layout pattern correction sequence may be determined based on reinforcement learning. The DRL module 1220 may determine a pattern correction procedure that maximizes the reward. Then, the PPC software 1250 may generate an optimal layout or pattern compensation sequence for forming a target layout. That is, the PPC software 1250 may provide a CD of an optimum pattern or a correction sequence as an output when a correction of each pattern is sequentially performed. The provided optimal CD and sequence may be a correction method capable of minimizing interference or issues caused by environmental changes resulting from the correction of each pattern.

PPC may be performed in a manner in which corrections for each pattern are collectively applied in a prediction layout for forming a target layout. However, since environmental changes occur at the same time as the batch correction is applied, such environmental changes cannot be reflected in the PPC. According to embodiments, time-dependent DRL may be applied to reflect interference between patterns generated during collectively applied corrections. Accordingly, the system may extract an optimal correction sequence or an optimal layout reflecting environmental changes between time-dependent patterns based on the learning of the DRL module 1220. As a result, an optimal layout or correction method that approximates the ACI layout may be provided using simulation results.

FIG. 4 is a diagram illustrating a layout optimization method using a DRL module according to an embodiment. Referring to FIG. 4, the DRL module 1220 may include a state inputter 1221, a CNN 1222, an action inputter 1223, an action value selector 1224, and a loss function generator 1225.

The state inputter 1221 may provide a state at a specific point in time to the input layer of the CNN 1222. An input provided as a state may be provided as a layout image at a specific point in time. For example, the state input may be a target layout desired to be obtained in the ACI step. The 1222 may generate a predictive layout to generate the target layout.

The CNN 1222 may receive a target layout provided as a state and generate a plurality of action values Q(xₜ, aⱼ) (1≤j≤m). That is, the CNN 1222 may receive a target layout image in one state without an action input and may generate ‘m’ number of action values Q(xₜ, aⱼ). In this way, the system may obtain an action value Q(xₜ, aⱼ) corresponding to a plurality of actions with only one state input without the need to update the action value (Q-value) each time an adjustment for each action or one pattern is applied.

The weights of the CNN 1222 may be in a learned state as values for generating a predicted layout for generating an input target layout (e.g., an ACI layout). Learning of the CNN 1222 may be performed through prediction for a PPC for various layout images including various patterns. That is, an optimal predicted layout or image may be generated through deep neural network learning for features of layout patterns. In addition, a separate action value (Q-value) may be simultaneously output for each of these actions of the CNN 1222.

The action inputter 1223 may provide a size correction of each pattern to the action value selector 1224. For example, the action inputter 1223 may input a skew application operation (e.g., a skew adjustment value) for adjusting the size of the first pattern as the first action ‘a₁’. When the selection of the action value Q(xt, a1) for the first action ‘a₁’ is completed, the action inputter 1223 may input a skew application operation for adjusting the size of the second pattern as the second action ‘a₂’. In this way, the action inputter 1223 may continuously input pattern size adjustment values until the skew applications to all patterns included in the target layout are completed. Although it has been described that one skew adjustment value is input for one pattern, a plurality of actions for applying skew adjustment values of various values to one pattern may be provided.

The action value selector 1224 may select an action value Q(xₜ, aₜ) corresponding to the action ‘aⱼ’ input by the action inputted 1223. That is, the action value selector 1224 may select the action value Q(xₜ, at) corresponding to the skew adjustment of the currently input action from among the plurality of action values generated by the CNN 1222.

The loss function generator 1225 may determine the loss function L(Φ) using the action value Q(xₜ, aₜ) selected by the action value selector 1224. The loss function generator 1225 may calculate the difference between the action value Q(xₜ, aₜ) selected in a current stage and a Q*(xᵢ, aᵢ) corresponding to the true value of the optimal action value. Q*(xᵢ, aᵢ) may be calculated from the CD of the target layout. For example, the loss function L(( ) may be expressed as in Equation (1) below

L(Ø)=[Q*(xᵢ,aᵢ)−Q(xₜ,aₜ)]² (1)

The progression of reinforcement learning occurs in the direction of choosing an action that minimizes the loss function L(Φ). That is, the sequentially input actions ‘aⱼ’ have a loss function that decreases as reinforcement learning progresses. When reinforcement learning is terminated, a layout pattern to which an optimal correction for generating a target layout is applied may be determined.

Correction of a time-dependent pattern may be applied through DRL, and correction of each pattern may be updated in a direction that minimizes a loss function. Accordingly, a predicted layout image corresponding to the minimum loss function may be selected as an optimal layout.

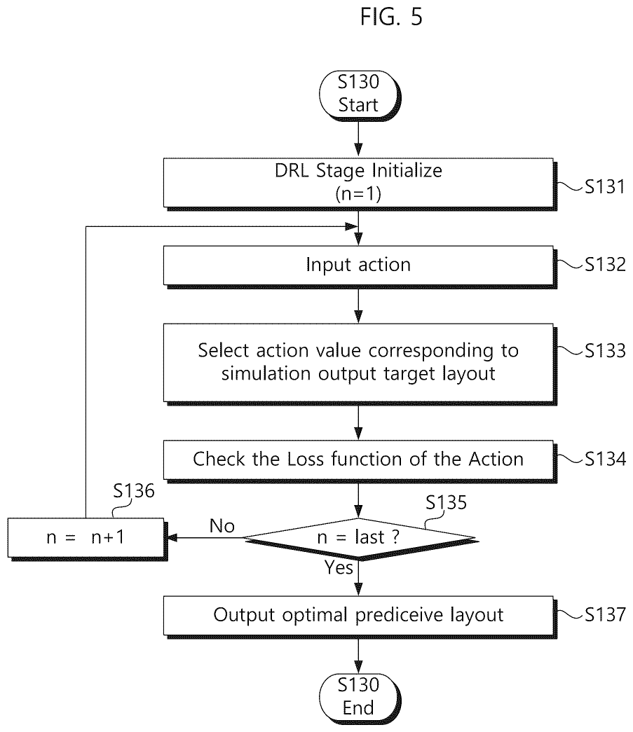

FIG. 5 is a flowchart illustrating operation S130 of FIG. 3 according to an embodiment. Referring to FIG. 5, DRL may include a process of determining a loss function L(Φ) for an action input and an action value (Q-value). The action may correspond to a numerical correction of each pattern included in the layout. The time-dependent numerical correction of the patterns may result in DRL in a direction approaching the target layout. Thus, the system may predict an optimal layout that appropriately indicates the mutual influence of patterns.

In operation S131, the layout optimization system 1000 may perform DRL state initialization. A stage of DRL may be initialized as n=1. That is, the number ‘n’ for selecting a pattern for applying numerical correction in DRL may be initialized to 1. The reinforcement learning operation may be performed on the total number of patterns included in the layout or the number of numerical corrections of each pattern.

In operation S132, the layout optimization system 1000 may input an action. An action for the first pattern P1 may be input. That is, as an action, the numerical correction value of the first pattern P1 may be be input to the action value selector 1224 (see FIG. 4). Numerical correction values may be provided by increasing or decreasing the size of the first pattern P1 in the horizontal or vertical direction.

In operation S133, the layout optimization system 1000 may select an action value corresponding to the simulation output target layout. The action value selector 1224 may select an action value (Q-value) corresponding to the input action. That is, an action value Q(xₜ, a₁) corresponding to the action a₁ input by the action inputter 1223 may be selected. Regarding the action values, in some embodiments, it may assumed that action values for all possible numerical correction values have already been derived through simulation by the CNN 1222. Therefore, for the action corresponding to the numerical correction of the first pattern P1, the action value selector 1224 may select and output the determined action value Q(xₜ, a₁).

In operation S134, the layout optimization system 1000 may check the loss function of the action. The loss function generator 1225 may determine the loss function L1(Φ) for the action ‘a₁’. The loss function generator 1225 may calculate a loss function based on the difference between the action value Q(xₜ, a₁) selected in a current stage and action value Q*(xᵢ, aᵢ) corresponding to a true value of the optimal action value. As the stages progress, reinforcement learning may occur in the direction of reducing the size of the loss function.

In operation S135, the layout optimization system 1000 may determine whether the number n is the last in a sequence. The DRL module 1220 may determine whether numerical adjustments for all patterns in the layout have been completed. That is, the DRL module 1220 may determine whether the pattern to which the numerical adjustment is applied corresponds to the last stage. If the pattern to which numerical adjustment is applied corresponds to the final stage (Yes direction where n=last), the method may proceed to operation S137. On the other hand, if the stage to which numerical adjustment is to be applied remains (No direction where n is not the last in the sequence), the method may proceed to operation to operation S136.

In operation S136, the layout optimization system 1000 may increment the value of n. The DRL module 1220 may increment n as n=(n+1) the DRL stage. Then, the method may return to operation S132 for continuing the DRL of the counted-up stage.

In operation S137, the layout optimization system 1000 may output the optimal predictive layout corresponding to a maximum reward. The DRL module 1220 may select an optimal layout learned through a DRL procedure. That is, the DRL module 1220 may select a pattern that provides the maximum compensation (e.g., the optimal pattern corresponding to a maximum reward) from among various layout patterns adjusted through various DRL processes and output the optimal layout.

Correction of a time-dependent pattern may be applied through application of DRL processes, and correction of each pattern may be updated in a direction that minimizes the loss function. Therefore, the predicted layout image corresponding to the minimum loss function or maximum compensation may be selected as the optimal layout.

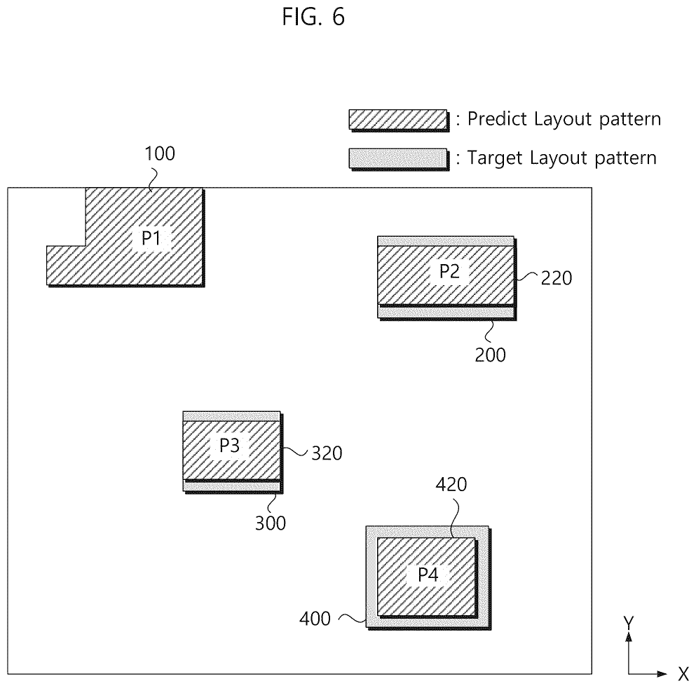

FIG. 6 is a diagram illustrating a target layout and a partial area of a predicted layout generated through simulation according to an embodiment. Referring to FIG. 6, a skew for PPC is determined based on a difference between a target layout and a predicted layout.

As described above, the target layout patterns 100, 200, 300, and 400 may be generated based on predicted layout patterns 100, 220, 320, and 420 through simulation (it is noted that in FIG. 6, a predicted layout pattern 100 may correspond to a target layout pattern as is described below, in that the predicted layout pattern 100 may match the target layout pattern or that the predicted layout pattern 100 is larger than the target layout pattern such that the target layout pattern is not explicitly shown in the view of FIG. 6). Based on the difference between the CDs of the predicted layout patterns 100, 220, 320, and 420 and the target layout patterns 100, 200, 300, and 400, the layout may be corrected through PPC.

The first pattern (P1, 100) shows a case where the CD of the layout predicted through simulation coincides with the CD of the target layout. That is, the first pattern (P1, 100) may correspond to a case where there is no skew between the target pattern and the predicted pattern or the skew is less than or equal to the allowable value. Accordingly, PPC may not be applied to the first pattern 100. On the other hand, each of the second to fourth patterns P2 to P4 may correspond to a case in which a CD on the target layout and a CD on the predicted layout have a difference greater than or equal to an allowable range. That is, each of the second to fourth patterns P2 to P4 corresponds to a case in which skew correction is required.

For example, in the case of the second pattern P2, the predicted pattern 220 may be the same in the X direction and shorter in the Y direction than the target pattern 200. Therefore, for correction, to the system may increase the size of the second pattern P2 in the Y direction on the layout. The prediction pattern 220 of the third pattern P3 may be predicted to be shorter than the target pattern 300 only in the Y direction. Therefore, in order to correct the third pattern P3, the system may implement an adjustment to increase the size of the pattern in the Y direction. The prediction pattern 420 of the fourth pattern P4 may be predicted to be shorter than the target pattern 400 in both the X and Y directions. Accordingly, to the system may increase both the X and Y directions in order to correct the fourth pattern P4.

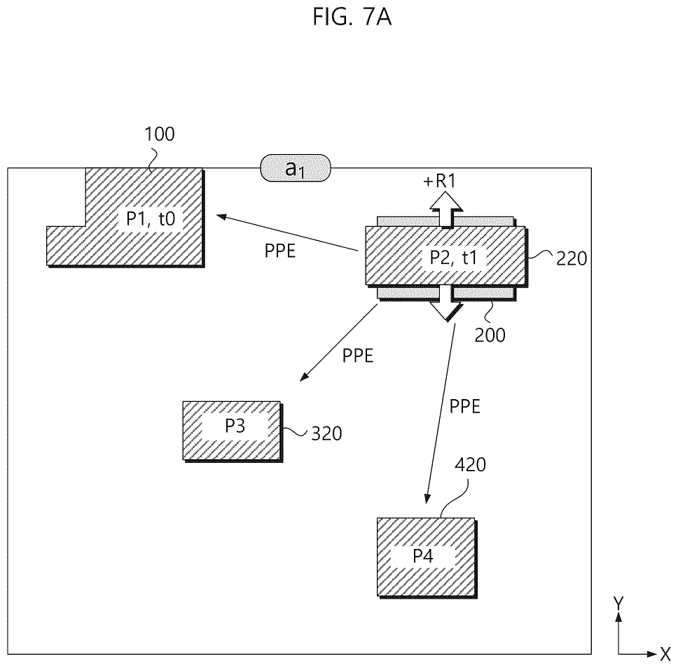

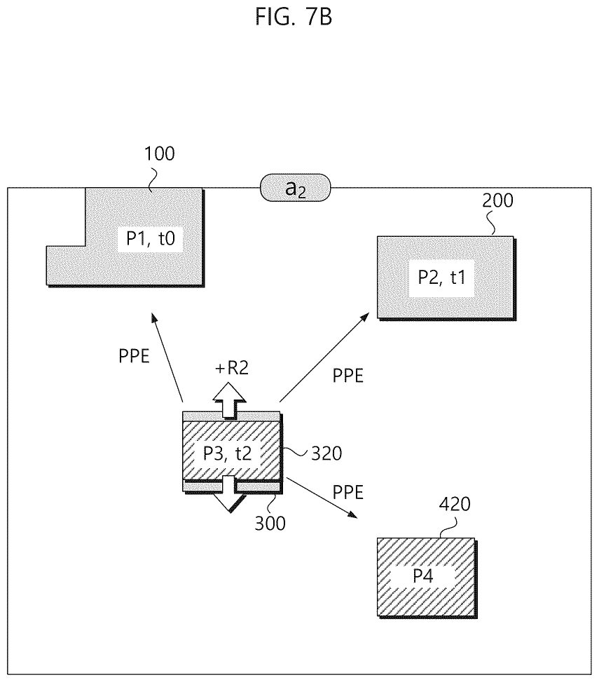

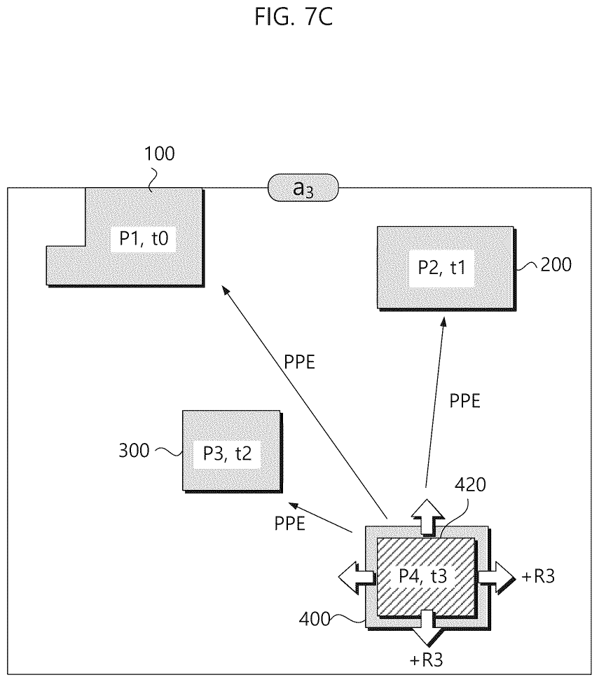

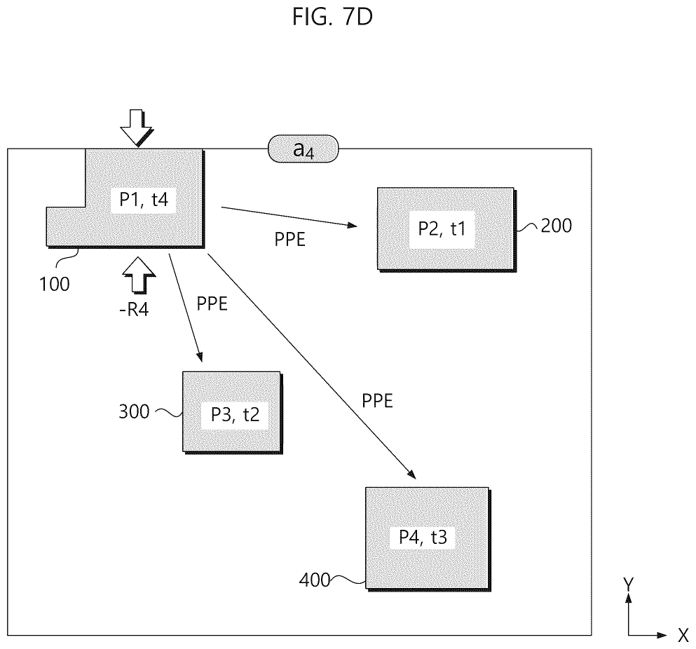

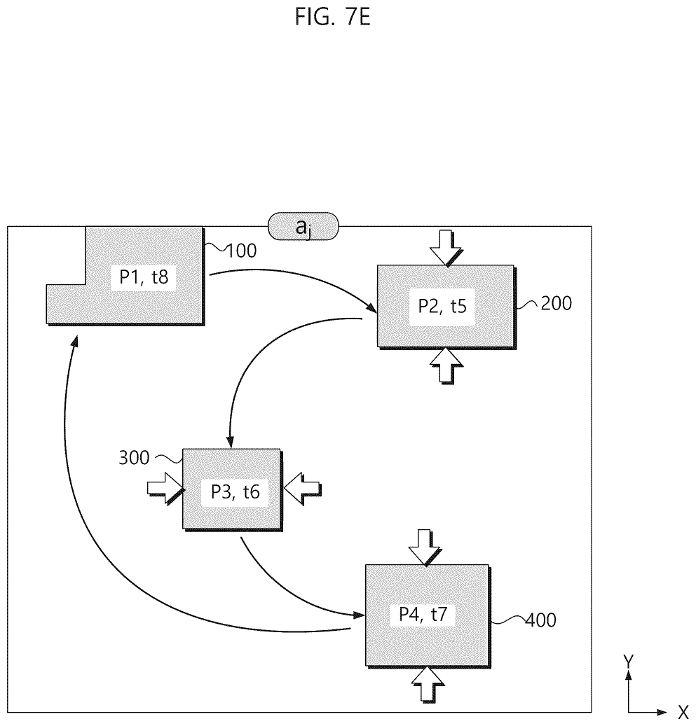

FIGS. 7A, 7B, 7C, 7D and 7E are diagram illustrating a process of proximity correction using the DRL according to an embodiment. According to embodiments, when correction of patterns is applied in a time-dependent manner, an optimal layout reflecting environmental changes may be generated through repetitive DRL. In some embodiments, it may be assumed that the simulation layout size and the target layout size of the first pattern P1 have a difference within an allowable range or are the same. Therefore, it may be assumed that the correction of the first pattern P1 is applied at time t0.

Referring to FIG. 7A, size correction of the second pattern P2 may be applied as a first action ‘a₁’ of the DRL. That is, to correct the second pattern P2, the size of the second pattern P2 in the Y direction on the target layout may be increased by ‘R1’. In this case, the influence of the environmental change according to the correction of the second pattern P2 may affect the remaining patterns P1, P3, and P4. That is, a process proximity effect (PPE) may occur in the remaining patterns P1, P3, and P4 based on the correction of the second pattern P2 at a time point t1. Accordingly, the correction of the first pattern P1 applied at the time point t0 may become incomplete according to environmental changes.

Referring to FIG. 7B, as a second action ‘a₂’ of the DRL, size correction of the third pattern P3 may be applied. That is, in order to correct the third pattern P3, the Y-direction size of the third pattern P2 may be increased by ‘R2’ on the target layout. Environmental changes may occur in the remaining patterns P1, P2, and P4 distributed within the influence range according to the correction of the third pattern P3. That is, the PPE may occur in the remaining patterns P1, P2, and P4 based on the correction of the third pattern P3. Accordingly, correction of the first pattern P1 corrected at time t0 and the second pattern P2 corrected at time t1 may become incomplete due to the influence of environmental changes.

Referring to FIG. 7C, as a third action ‘a₃’ of the DRL, size correction of the fourth pattern P4 may be applied. That is, in order to correct the fourth pattern P4, the X-direction size and Y-direction size of the fourth pattern P4 on the target layout may be increased by ‘R3’. Environmental changes may occur in the remaining patterns P1, P2, and P3 distributed within the influence range based on the correction of the fourth pattern P4 applied at time t3. That is, the correction of the fourth pattern P4 may affect the remaining patterns P1, P2, and P3. Therefore, the correction of the first pattern P1 corrected at time t0, the second pattern P2 corrected at time t1, and the third pattern P3 corrected at time t2 may be affected by the environmental change at time t3. Accordingly, the correction of these patterns P1, P2, and P3 may be considered incomplete.

Referring to FIG. 7D, as a fourth action ‘a₄’ of the DRL, size correction of the first pattern P1 may be applied. That is, in order to correct the first pattern P1, the Y-direction size of the first pattern P1 may be reduced by ‘R4’ on the target layout. Environmental changes may occur in the remaining patterns P2, P3, and P4 distributed within the influence range based on the correction of the first pattern P1 applied at the time t4. That is, the environmental change based on the correction of the first pattern P1 may affect the remaining patterns P2, P3, and P4. Therefore, the corrections of the second pattern P2 corrected at time t1, the third pattern P3 corrected at time t2, and the fourth pattern P4 corrected at time t3 may be affected by the environmental change at time t4. The influence of these environmental changes may be applied to each of the patterns through DRL that is learned in a direction of minimizing the loss function.

Referring to FIG. 7E, an iterative loop of the DRL in which size adjustment of each pattern is input as an action is shown as an example. As the fifth action ‘a₅’, size correction of the second pattern P2 may be applied again at time t5. That is, to correct the second pattern P2, the size of the second pattern P2 may be adjusted on the target layout. In the second pattern P2, correction at time t1 and correction at time t5 may also occur. This size adjustment may occur repeatedly until DRL is finished.

As a subsequent sixth action ‘a₆’, the correction of the third pattern P3 may be applied again at time t6. That is, the size may be adjusted on the target layout to correct the third pattern P3. The third pattern P3 may be corrected at time t6 following the correction applied at time t2.

As a subsequent seventh action ‘a₇’, the correction of the fourth pattern P4 may be applied again at the time point t7. That is, the size may be adjusted on the target layout to correct the fourth pattern P4. The fourth pattern P4 may be corrected at time t7 following the correction applied at time t3. Iterative correction of these patterns may occur continuously until DRL is completed.

Each of the embodiments provided in the above description is not excluded from being associated with one or more features of another example or another embodiment also provided herein or not provided herein but consistent with the disclosure

While the disclosure has been particularly shown and described with reference to embodiments thereof, it will be understood that various changes in form and details may be made therein without departing from the spirit and scope of the following claims.

What is claimed is:

1. A layout optimization system for correcting a target layout of a semiconductor process, the system comprising:
a deep reinforcement learning (DRL) module;
a memory storing instructions; and
a processor configured to execute the instructions to:
receive a target layout;
generate, by the DRL module, a prediction layout by applying a simulation to the target layout,
generate, by the DRL module, an optimal layout based on the prediction layout; and
apply a size correction to at least one pattern of the prediction layout based on the optimal layout.

2. The system of claim 1, wherein the DRL module comprises a deep neural network configured to generate value functions corresponding to a plurality of action inputs.

3. The system of claim 2, wherein the plurality of action inputs comprises an action corresponding to an adjustment of a size of each patterns of the target layout.

4. The system of claim 3, wherein each of the plurality of action inputs corresponds to a size adjustment applied at different times.

5. The system of claim 2, wherein the deep neural network comprises a convolutional neural network (CNN) trained with weights indicating a mutual influence of patterns of the prediction layout.

6. The system of claim 2, wherein the DRL module, comprises:
an action value selector configured to select one of the value functions corresponding to one of the plurality of action inputs; and
a loss function generator configured to generate a loss function by comparing a value function selected by the action value selector with a true value function based on the target layout.

7. The system of claim 1, wherein the DRL module is configured to perform a reinforcement learning operation that reduces a difference between the prediction layout and the target layout based on:
a correction of patterns used as an action input; and
the target layout used as a state input.

8. The system of claim 7, wherein the optimal layout corresponds to a maximum action value in the reinforcement learning operation or is derived from a learning result having a maximum reward.

9. A learning method of a layout optimization system, the learning method comprising:
receiving a target layout;
generating a predicted layout based on the target layout,
generating a plurality of action values by performing a simulation on the predicted layout;
receiving a change to at least one pattern of the predicted layout as an action input;
selecting a first action value of the plurality of action values corresponding to the action input; and
determining a loss function by comparing the selected first action value with a second action value corresponding to the target layout.

10. The learning method of claim 9, wherein the generating the plurality of action values is performed using a convolutional neural network (CNN).

11. The learning method of claim 10, further comprising:
receiving, by the CNN, the target layout as an input layer; and
outputting, by the CNN, the plurality of action values from an output layer.

12. The learning method of claim 11, wherein the CNN comprises a weight indicating an effect of a change between patterns of the target layout.

13. The learning method of claim 9, wherein the action input corresponds to a size adjustment of at least one pattern of the target layout.

14. The learning method of claim 13, wherein the action input comprises a size adjustment applied a plurality of times at different time points for the at least one pattern of the target layout.

15. The learning method of claim 9, further comprising:
receiving a size adjustment as an action input,
selecting one of the plurality of action values, and
determining the loss function in an operation loop.

16. The learning method of claim 15, further comprising selecting, in the operation loop, a layout pattern corresponding to an action value that minimizes the loss function as an optimal layout.

17. A method, comprising:
receiving a target layout;
generating a prediction layout by applying a simulation to the target layout;
generating an optimal layout based on the prediction layout; and
applying a size correction to at least one pattern of the prediction layout based on the optimal layout.

18. The method of claim 17, wherein the simulation is applied based on a convolutional neural network (CNN) trained with weights that numerically indicate a mutual influence of the at least one pattern of the prediction layout.

19. The method of claim 17, further comprising performing deep reinforcement learning (DRL) by:
receiving a size adjustment for the at least one pattern of the prediction layout as an action input;
selecting a first action value of a plurality of action values corresponding to the action input; and
determining a loss function by comparing the selected first action value with a second action value corresponding to the target layout.

20. The method of claim 17, wherein the target layout corresponds to an after cleaning inspection (ACI) critical dimension (CD).
